(19) United States
(12) Patent Application Publication
(10) Pub. No.: US 2013/0245507 A1
(43) Pub. Date: Sep. 19, 2013

(54) DEVICE FOR MASSAGING THE HUMAN OR ANIMAL BODY

(71) Applicant: David Khorassani Zadeh, Eaubonne (FR)

(72) Inventor: David Khorassani Zadeh, Eaubonne (FR)

(21) Appl. No.: 13/989,487

(22) PCT Filed: Nov. 24, 2011
(86) PCT No.: PCT/FR2011/000619

§ 371 Date: May 24, 2013

(30) Foreign Application Priority Data
Nov. 25, 2010 (FR) 1004576

(51) Int. Cl. A61H 9/00

(52) U.S. Cl. CPC A61H 9/0057
USPC 601/11

(57) ABSTRACT

Massage appliance comprising a hollow body (10) delimiting an internal volume connected (7) to a suction source so as to form a suction chamber by bearing with its edge (2) on the skin, said hollow body (10) enclosing at least one internal bearing element able to act by compression on the skin, when the internal volume is at an under pressure; it has an actuator (11) for exerting on the skin, by way of at least one internal bearing element, a force F applied to said element(s) in a continuous manner, at least one of the internal bearing elements thus acting on the skin with a localized continuous compression.

This invention concerns a device for massaging the human or animal body of a living subject receiving treatment, including, firstly, a hollow body to be held against the skin by suction means, and, secondly, supports to apply localised compression to the deep layers of the skin to be treated.

Numerous patents have already proposed massaging devices similar to that of this invention. The massaging devices disclosed in the prior art essentially use suction means to create a depression in a suction chamber, with the skin thus suctioned coming into contact with supports, which, in a direction substantially orthogonal to the skin to be treated, are fixed with regard to the direction of suction.

In Swiss patent 168279, it is stated that the device comprises a hollow body containing an element that acts mechanically on the part of the skin that is subject to negative pressure created by suction that prevails in the hollow body; the element may be a protrusion that is of a piece with the hollow body or a wheel having an axle borne by the hollow body, or a membrane with elevations; in all cases, the compression of the skin on the support is exclusively generated by the negative pressure in the suction chamber. Given that the amount of negative pressure to which the skin can be subjected without causing injuries is necessarily limited, it follows that the compression of the skin in the areas that are in contact with the support is also necessarily limited, such that such a device cannot be used on the deep layers of skin or the subjacent tissues or muscular areas.

In French patent application 2 880 799, the support that compresses an area of skin is a wheel, and, there too, the compression by the wheel is essentially a function of the negative pressure established in the suction chamber; however, this device can be used dynamically due to the presence of the wheel.

In European patent application EP 0 800 812, rails of the walls of two suction chambers are used as supports, such that, there, too, the compression of certain areas of skin can only be limited, as the walls delimit the suction chambers, and, additionally, the rail of a wall has a limited surface area, preventing the use of substantial negative pressure to the risk of injuries to the skin.

The same disadvantage is presented by the devices described in the two patent applications O2010/095855 and WO 2010/095856, in French patent application 2785177, Russian patent 2128491, patent application US 2007/0027411, and German utility model 20 2007 016179U1.

Lastly, in French patent 1 501 054, a simply designed device is proposed that includes a plurality of suction chambers, each separated from the other by parallel bars between them; nothing is proposed to affect the deep layers of skin, as the only supports are the separation bars of the various suction chambers, and the device is used manually by applying “moderate” pressure on the part of the body to be massaged; the device must be moved on the skin to be treated in order to produce a wave in the epidermis, requiring sliding the device on the skin; it further states that a lubricant is spread on the part to be massaged in order to facilitate this sliding. It is clear that the pressure that can be applied manually on such a device can only be mild, as it must slide on the skin; accordingly, the compression by the separation bars between two suction chambers is necessarily weak, and cannot act on the deep layers of the skin.

The invention seeks to simultaneously apply to the skin to be treated, on the one hand, suction as described in any of the aforementioned known-art patents, and, on the other hand, localised compression applied continuously (but not necessarily constantly) over the course of the suction, as described in patent EP 1 800 644. In patent EP 1 800 644, the applicant already described a modular device for applying pressure by points on a human or animal body; this device may comprise, in particular, an elongated pylon suited to receive means of attachment, and a plurality of pressure bases, each being a component suited to be attached to one end of the pylon to deliver to the pylon the pressure to be applied to the human or animal body, whereby the bases are suited to receive various parts of the body of the therapist, and, lastly, a pressure head attached to the other end of the pylon, to apply to the human or animal body the pressure transmitted to the pylon by the pressure base.

The devices described in patent 1 800 644 allow for the performance of continuous-pressure massages, i.e., they use a substantial compression force on certain localised parts of the body of the patient to be treated, allowing for beneficial effects on deep tissues of the body. Generally, such devices do not cause substantial pain, as the compression is carried out progressively, such that the skin to be treated is not suddenly subjected to substantial force; furthermore, the pressure head is not moved relative to the skin whilst the pressure is applied, thus avoiding all pain related to friction on the skin The result is one possibility for treating the deepest layers of the skin and the subjacent tissues without causing intolerable pain to the subject to be treated.

The applicant has now found that living subjects can be massaged by combining suction means with means of generating substantial localised compression on the skin of the subject. Following trials, the applicant found, not only according to his observations but also the experiences of the subjects treated, that such a combination causes surprising effects. The blood circulation is improved, the “orange peel” effect is mitigated, and subjacent muscle tissues are stimulated, providing relief in particular to subjects suffering from myalgias.

Thus, the invention concerns a device for massaging a living subject to be treated-comprising a hollow body delimiting an internal volume by means of a lateral wall and a connecting wall, whereby the lateral wall extends between the connecting wall and a peripheral edge to be placed statically on an area of the skin of the subject to be treated, whereby the internal volume is connected to a suction system in order to constitute, by applying the peripheral edge to the skin, at least one suction chamber capable of being placed under negative pressure relative to the environment of the device, whereby the hollow body includes, in its internal volume, at least one internal support suited to compress the skin of the subject to be treated when the internal volume is connected to the reduced treatment pressure established by the suction system, characterised in that it further includes at least one actuator to apply mechanically to the skin, by means of at least one internal support in the hollow body, a force F applied to the support(s) in a continuous manner, either variable or not, whereby at least some of the internal supports thus apply localised continuous compression to the skin.

Within the meaning of this application, an actuator may apply the force F via any means, in particular, as described below in the various exemplary embodiments of the invention, by mechanical transmission of a force applied by an operator or a pneumatic action, but also by hydraulic, electrical, or magnetic means.

The force F, which allows for the application of continuous, localised compression on certain areas of the skin, is applied by means of at least one actuator. The presence of this actuator, which is independent of the suction system, allows for the particularly worthwhile results of the combination of the two known-art parts, i.e., the part related to the use of a suction system and that related to the use of a force F applied by means of an actuator. In a preferred embodiment, such an actuator exercises a force F having a value independent of the pressure established by the suction system.

In a first variant, it may be provided for the supports to be fixed inside the hollow body; advantageously, the internal supports include at least one protruding finger and/or at least one elongated boss, the free end of which is at an adjustable distance from a regular, continuous surface passing through the peripheral edge of the lateral wall.

In another variant, at least some internal supports are mobile within the hollow body due to an actuator, in a direction substantially perpendicular to a regular, continuous surface passing through the peripheral edge of the lateral wall of the hollow body; in this case, it may be provided that a mobile support consist of a rectilinear finger, the free end of which is orientated towards the outside of the hollow body and is rounded.

The internal volume may be divided into various suction chambers, separated by at least one internal wall, whereby each internal wall has a free edge substantially at the level of a regular, continuous surface passing through the peripheral edge of the lateral wall of the hollow body. In one variant, the suction chambers of the hollow body are subject, independently and/or sequentially, to one or more reduced pressure(s) by means of a distribution device. Each internal wall may be connected to the lateral wall of the hollow body such that its free edge is connected to the peripheral edge of the lateral wall.

In another variant, the hollow body constitutes the pressure head of an actuator including a pylon, one end of which is mechanically connected to the hollow body and the other receives a pressure base, which delivers to the pylon the continuous force F to be applied via the support(s) to the area(s) of skin that are under continuous compression. The force F acting on the hollow body may be applied by a pressure base suited to receive part of the body of the therapist treating the subject by means of the device. The pressure base may be a mobile connection connected to a piece of equipment carried by the therapist.

According to a second embodiment, the force F acting on the hollow body is applied by clamping means supported by the subject to be treated.

In a third embodiment, a mobile support is moved by the actuator by varying a control pressure P2 independent of the reduced pressure P1, acting in the internal volume of the hollow body.

Advantageously, the hollow body includes on its outside, borne by its lateral wall, at least one flexible enclosure that is deformable by pressing it against the skin of the subject to be treated, whereby the deformation of the enclosure is obtained by varying the pressure within the enclosure and causing pinching of the skin in order to join the hollow body with the skin on which it is supported.

In one variant, the hollow body has on its outside at least one external support suited to act on the skin via an additional continuous compression, whereby the additional continuous pressure acts on an area of the skin of the subject to be treated from outside the peripheral edge of the lateral wall of the hollow body and has insufficient intensity to cancel out the pressure of the peripheral edge on the skin. However, it is also possible to provide for the hollow body to have on its outside at least one external support suited to act on an area of the skin of the subject to be treated via an additional continuous compression, from outside the peripheral edge of the lateral wall of the hollow body, with any degree of intensity not capable of cancelling out the pressure of the peripheral edge on the skin of the subject to be treated due to a clamping means acting externally on the hollow body and supported by the subject to be treated.

In another embodiment, the force F generated by the actuator(s) causes sufficient deformation of the lateral walls of the hollow body to cause a constant or pulsatile reduction in the negative pressure in the internal volume due to the elasticity of the lateral wall. The elasticity of the lateral wall may be chosen such that the negative pressure in the internal volume causes a slight leak in order to generate mechanical oscillation of the lateral wall and vibration on the peripheral edge of the hollow body.

To better understand the subject-matter of the invention, various embodiments shown in the attached drawings will be described by way of example only.

In these drawings:

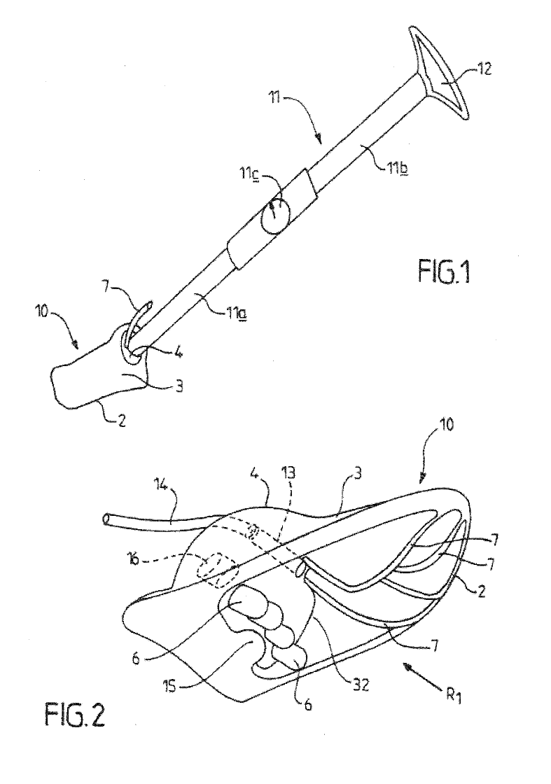

FIGS. 1-6 show a first embodiment of a device according to the invention. FIG. 1 is a perspective view of the assembly formed by an actuator and its related hollow body: The actuator is a device as described and protected by patent EP 1800644; the related hollow body is that shown in detail in FIGS. 2-6 of this application;

FIG. 2 is a perspective view of the inside of the hollow body of FIG. 1;

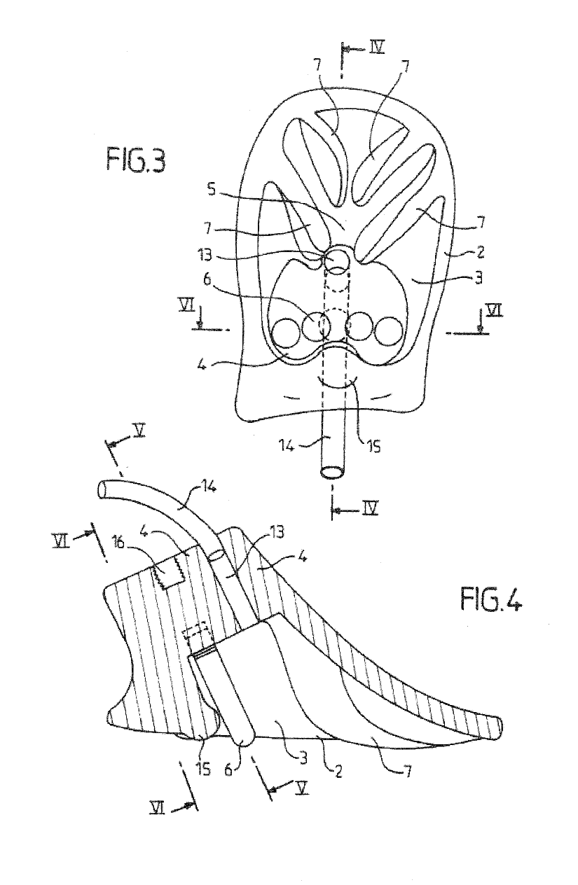

FIG. 3 is a plan view from below of the hollow body of FIG. 2, according to the arrow R1 of FIG. 2;

FIG. 4 is cutaway view based on IV-IV of FIG. 3;

FIG. 5 is cutaway view based on V-V of FIG. 4;

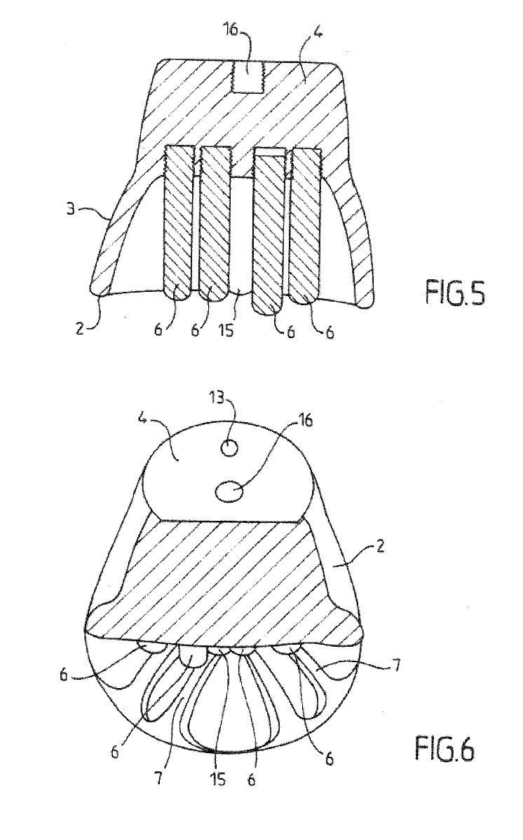

FIG. 6 is cutaway view based on VI-VI of FIG. 4;

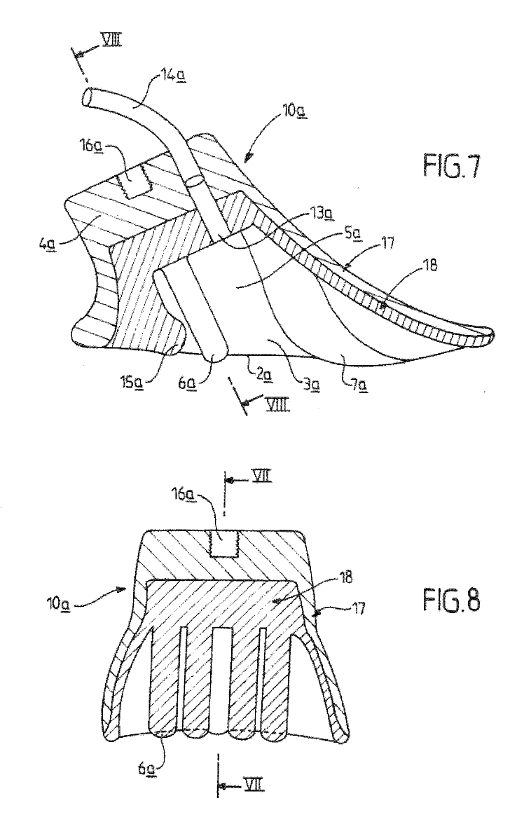

FIG. 7 is a longitudinal section of a hollow body according to a variant of the first embodiment corresponding to FIGS. 1-6 based on VII-VII of FIG. 8;

FIG. 8 is a cross section of the hollow body of FIG. 7, according to VIII-VIII of FIG. 7;

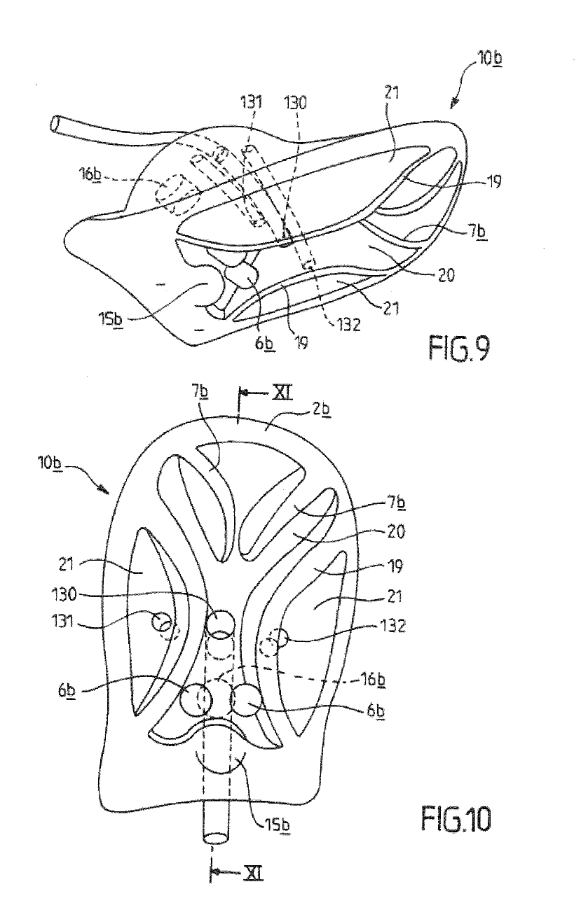

FIG. 9 is a perspective view of another variant of the hollow body of the first embodiment corresponding to FIGS. 1-6;

FIG. 10 is a plan view of the bottom of the hollow body of FIG. 9;

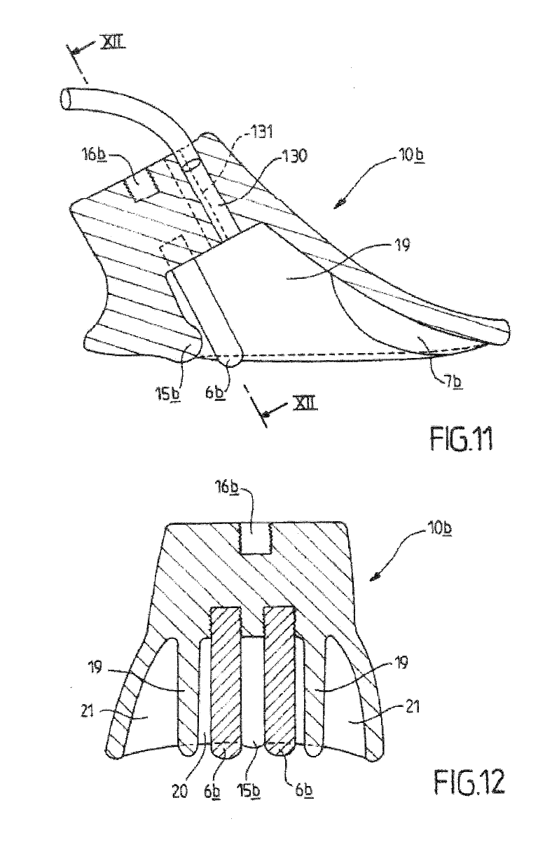

FIG. 11 is a cross section of the hollow body of FIG. 10, according to XI-XI of FIG. 10;

FIG. 12 is a cross section of the hollow body of FIG. 11, according to XII-XII of FIG. 11;

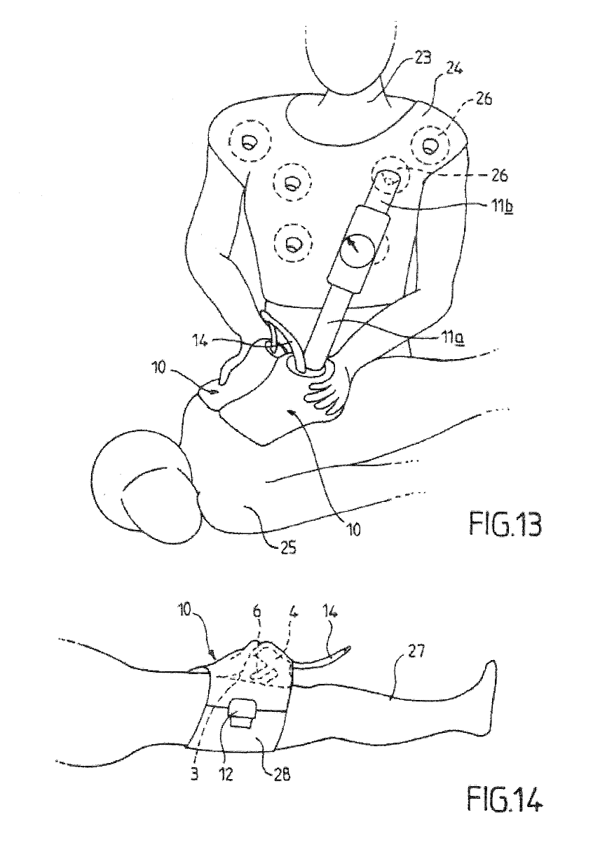

FIG. 13 is a perspective view of a therapist carrying a piece of equipment acting on a patient by means of a device according to the invention (actuator plus hollow body), whereby the device is associated with a hollow body and no actuator;

FIG. 14 is a perspective view of the leg of a patient treated by means of a hollow body on which the force F is generated by a strap surrounding the patient's leg;

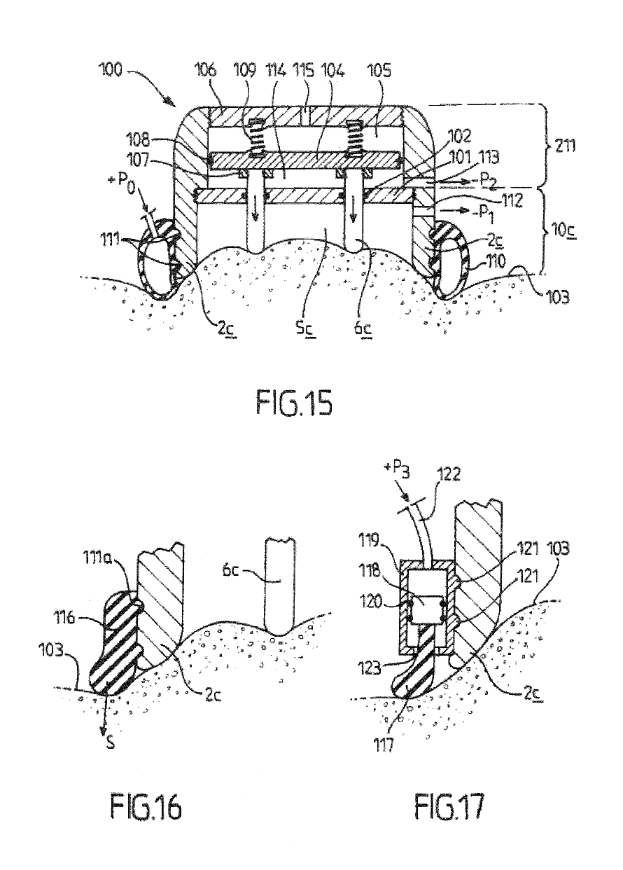

FIG. 15 is a schematic cutaway representation of a hollow body, the actuator of which is a suction system that moves protruding fingers, with the position of the hollow body on the skin being maintained by one or more enclosure(s) subject to internal pressure;

FIG. 16 is a cutaway view of a variant of the peripheral enclosure of the hollow body of FIG. 15, which may be adapted to any type of hollow body, in particular that of FIG. 15;

FIG. 17 is a schematic cutaway view of another variant of the peripheral enclosure of the hollow body of FIG. 15, which allows for adjustment of the compression obtained by the elements of the enclosure.

Referring to FIGS. 1-6, it can be seen that the device according to this first embodiment of the invention includes an actuator as described in patent EP 1800644; essentially, this actuator includes three parts:

on the one hand, it includes an elongated pylon 11 consisting of two shaft halves 11a, 11b connected a dynamometer 11c capable of measuring the force exercised between the two shaft halves 11a and 11b to bring them closer to one another. The shaft half 11b includes on its free end a plate 12 referred to as the “pressure base”. The pressure base 12 is formed so as to receive various parts of the anatomy of the therapist capable of applying force to the shaft half 11b to bring it closer to the shaft half 11a. The shaft half 11a is connected by end opposite the dynamometer 11c to a hollow body designated as a whole as 10.

The hollow body 10 delimits an internal volume by means of a lateral wall 3 and a connecting wall 4. The lateral wall 3 extends between the connecting wall 4 and a peripheral edge 2. The peripheral edge 2 is the free end of the lateral wall 3, which is connected on the opposite side to the connecting wall 4. The peripheral edge 2 defines a substantially flat opening placing the outside in communication with the internal volume of the hollow body 10. It is intended to be placed on the skin of the subject to be treated Advantageously, the connecting wall 4 is substantially flat, and fauns an acute angle with the plane defined by the peripheral edge 2. The shaft half 11a is connected with the hollow body 10 by placing the threaded free end of the shaft half 11a in a drilled hole 16 arranged in the connecting wall 4.

The internal volume is connected to a suction system (not shown) via a channel 13, which traverses the connecting wall 4, thus allowing the internal volume to be connected to a suction tube 14. The internal volume of the hollow body 10 thus constitutes a suction chamber 5. The suction system may be coupled to a computer module allowing the pressure in the suction chamber 5 to be programmed.

The hollow body 10 further includes, in its internal volume, internal supports arranged in the suction chamber 5, consisting of four protruding fingers 6 and four elongated bosses 7. The bosses 7 are arranged longitudinally in front of the suction chamber, i.e., in the area of the hollow body farthest from the connecting wall 4. They extend in the direction of the skin of the subject to be treated such that their free edges are located substantially on the plane defined by the peripheral edge 2. The free edge of the bosses 7 is rounded and suited to enter into contact with the skin of the subject to be treated without damaging the skin.

Other supports may be provided, as long as their contact surface with the skin does not injure the skin when the suction chamber 5 applies the hollow body 10 to the skin. In the embodiment shown in FIGS. 1-6, in this regard, an additional boss 15 is shown that is arranged inside the suction chamber 5 on the side on which the elongated bosses 7 are not located.

The protruding fingers 6 have one end borne by the connecting wall 4; their other end is free substantially on the plane of the peripheral edge. In the embodiment described, these fingers are screwed into corresponding holes in the connecting wall 4, allowing the position of their free end to be adjusted in relation to the plane of the peripheral edge 2.

The lateral wall 3 and the connecting wall 4 are made of a material that is sufficiently resistant to withstand the force F applied to the hollow body 10 by the shaft half 11a and transfer that force to the skin of the subject to be treated. However, it is possible to provide for certain parts of the peripheral edge 2 to be made of a material that is sufficiently deformable to adapt the hollow body 10 to elevations in the skin to be treated, thus ensuring the seal of the suction chamber 5 during the massage. Likewise, the fingers and bosses are made of a material that is sufficiently resistant to transfer the force F to the skin of the subject to be treated. However, it is possible to provide for bosses made of a material that is deformable depending on physical conditions, such that the suction allows for slight pinching of the skin of the subject to be treated in certain conditions: An example of such a condition would be an increase in temperature. A material with shape memory may also be used.

The external face of the connecting wall 4 comprises two openings: One is the exit of the drilled hole 16 capable of receiving the threaded end of the shaft half 11a of the pylon 11; the other corresponds to the exit of the channel 13 to which the suction tube 14 is connected.

Additionally, the hollow body of the device described above may additionally include means of heating and/or cooling (not shown) the skin of the subject to be treated, e.g., a heating resistor or an air circuit independent of the suction chamber, allowing hot or cold air to be injected. The hot air stimulates the blood circulation and perspiration, facilitating treatment. By alternating hot/cold air, the immune system may be stimulated in a known manner, thus improving the overall wellbeing of the subject to be treated. The hollow body of the device may also comprise means for electrically stimulating the skin to be treated, in order to further the treatment, e.g., by means of contractions of the muscles located under the skin to be treated. Other stimulation means are possible, such as infrared or ultrasound waves, the effects of which are known to the art.

Depending on the use intended for the device of the invention, the hollow body 10 may have different configurations to combine a shape and dimensions that are suited to a specific part of the body of the subject to be treated and/or to a specific treatment. By way of example only, a hollow body with a circular peripheral edge allows for massaging the shoulder, whilst a rectangular hollow body is suited to massaging the flat areas of the body, such as the back. The hollow body of a device according to the invention may be made in a size that is sufficient to cover a substantial part of the body of the subject to be treated.

The device of the invention is suited to treat a living subject, preferably a human or an equine. The treatment combines steps of support, negative pressure, and/or movement of the hollow body: The various steps are carried out for specified durations. The suction chamber 5 is generally hermetically sealed when the hollow body 10 is applied to the skin, creating, by means of negative pressure, movement of the skin to be treated against the protruding fingers 6 and the elongated bosses 7. The suction is carried out by means of a suction system (not shown) via the channel 13 and the tube 14.

The device of the invention is preferably used with the involvement of a therapist. The therapist using the device must apply a force F continuously, but not necessarily constantly, to at least one of the supports of the hollow body 10 in the direction of the skin of the subject to be treated. The force F may be applied by any suited means, in particular either mechanically, by a physical action of the therapist, or by hydraulic or pneumatic action controlled by the therapist. In the case of physical action of the therapist as described in patent EP 1 800 644, the force F may be between 10 and 250 Newtons, and, preferably, between 30 and 200 Newtons; it may be continuously maintained for a period of 5 s to 3 min. The same values may be obtained by a different actuator, in particular a hydraulic or pneumatic actuator. The force F thus applied by the therapist is sufficient to produce effects on the deepest layers of the skin without injuring the subject to be treated.

Treatment using the device of the invention is carried out on specified points on the body, some of which are disclosed in patent EP 1 800 644. When the device is held on the skin of the subject to be treated, the protruding fingers allow it to be pressed against a point on the skin, whilst the bosses allow for pressing against a strip. If the pressure is combined with movement of the device along the skin, deep treatment is carried out on a line by means of the protruding fingers and on a surface by the bosses. It is possible to provide for supports that would provide pressure to a surface. The effects of the suction on the skin to be treated are improved by the force F, which applies pressure to the skin to be treated: In fact, it has been surprisingly found that the effect of the supports on the deep tissues of the skin is promoted by suction stimulating superficial circulation and promoting drainage of the subcutaneous fatty tissue. When the suction source is coupled to a computer system, the suction may be programmed, i.e., it is possible to control the intensity of the suction and/or program continuous or non-continuous suction and/or adjust the duration of each of the operations of the suction programme.

The adjustable height of the protruding fingers 6 also allows for the hollow body 10 to be adapted to a specific area of the body and/or a specific treatment: By way of example only, the treatment of areas of the body where there are superficial osseous elevations necessitates fingers that do not exceed the surface area defined by the peripheral edge 2 of the lateral wall. Furthermore, the configurations of the hollow body 10 combine a number and position of the protruding fingers 6 and/or the elongated bosses 7 that are also suited to a specific part of the body of the subject to be treated and/or a specific treatment.

The combination of means to this variant of the invention has beneficial effects on the superficial and deep layers of the skin and connective tissue, but also on subcutaneous muscle, bone, and/or joint tissue. In fact, the suction, combined with the pressure of the fingers and bosses, stimulates the skin superficially, allowing for improvement in the blood circulation and movement of the subcutaneous tissue. In this way, it is possible to improve the quality of the skin, in particular by mitigating the “orange peel” effect. Furthermore, the combination of the effects of the suction with those of the force F stimulates subcutaneous muscle tissue, allowing for sustained relief for subjects suffering from myalgias such as fibromyalgia. Treatment with the device of the invention also allow for improvements in the posture of subjects, e.g., in the case of kyphosis.

With regard to FIGS. 7 and 8, it can be seen that the massage device according to this variant of the invention includes a hollow body 10a analogous to that of the variant shown in FIGS. 1-6 of the invention: The reference numbers of the various parts of the hollow body 10a are identical to those of the corresponding parts of the hollow body 10, but followed by the letter a. The hollow body 10a consists of a housing 17 and a sole 18. The sole 18 laterally delimits the internal volume 5a, which constitutes a suction chamber. The part of the peripheral edge 2a of the lateral wall 3a held against the skin of the subject to be treated is formed by the sole 18, but hollow bodies 10a are possible in which this part is formed by the housing 17.

The suction chamber 5a is connected to a suction source (not shown) via a channel 13a arranged in the sole 18 and the part of the housing 17 forming the connecting wall 4a. A suction tube 14a is connected to the channel 13a, allowing for communication between the suction chamber 5a and the suction system (not shown).

Analogously to the embodiment of FIGS. 1-6, the device also comprises supports of the hollow body 10a on the skin of the subject to be treated, consisting of protruding fingers 6a, elongated bosses 7a, and a rounded boss 15a. These supports are an integral part of the sole 18. The height of the protruding fingers 6a cannot be adjusted. The housing 17 and the sole 18 are made of a material that is sufficiently resistant to withstand the force F applied to the hollow body 10a and transfer that force to the skin of the subject to be treated. The housing 17 receives the pylon of an actuator according to patent EP 1 800 644 as shown in FIG. 1 of this application, with the shaft half connected to the hollow body 10a being screwed into a drilled hole 16a arranged in the housing 17.

The sole 18 may consist of a flexible thermoplastic polymer or a polymer with shape memory. It may be provided for the suctions to allow for movement by deformation of the elongated bosses. The sole may include at least one compound that is bioactive on the skin of the subject to be treated, e.g., a cosmetic compound and/or a drug, in particular a sustained-release preparation.

With regard to FIGS. 9 and 12, it can be seen that the device according to this variant of the invention comprises a hollow body 10b analogous to that of the foregoing variants. As above, the reference numbers of the various parts of the hollow body 10b are identical to those of the corresponding parts of the hollow body 10, but followed by the letter b. The internal volume of the hollow body 10b is divided by two internal walls 19 to delimit a central suction chamber 20 and two lateral suction chambers 21. The suction chambers are connected to a suction system (not shown) by independent channels 130, 131, 132 connected to independent suction tubes. The central suction chamber 20 is connected to the suction system by a central channel 131; the lateral chambers 21 are connected by two channels 130, 132. The suction system allows for the generation of reduced pressures having different values in each suction chamber.

The device according to this variant of the invention further comprises protruding fingers 6b, elongated bosses 7b, preferably provided in the central suction chamber, as well as rounded bosses 15b.

The device of this variant of the invention is used analogously to that of the foregoing variants, with the additional use of different degrees of negative pressure in each suction chamber. It is thus possible to generate greater suction in the lateral chambers in order to create folds of skin of differing sizes. The result is a new way of carrying out palpating and rolling massages, if the device is moved relative to the skin to be treated.

In the first embodiment described above, the actuator used was that described in patent EP 1 800 644, and schematically represented in FIG. 1. The force applied on a support in a continuous fashion is obtained by a therapist pushing on a pressure base that is part of the actuator. However, depending on the action to be carried out on the hollow body and the physiological constitution of the therapist, it may be useful not always to use the same pressure base. Furthermore, it may be useful to use multiple hollow bodies on the same patient simultaneously, with at least one of them connected to an actuator of the aforementioned type. This is why the invention proposes a device corresponding to that shown in FIG. 13. FIG. 13 shows a therapist 23 wearing a vest 24 to treat a patient 25. The vest 24 includes a plurality of female fasteners 26 in which the ends of shaft halves 11b of pylons of the device, as shown in FIG. 1 and described in this specification, can be hooked. FIG. 13 shows a shaft half 11b affixed to a female fastener 26, with the shaft half 11a of this actuator being connected to a hollow body 10 (or 10a) as described above; the inside of the hollow body is subject to negative pressure by the tube 14. The patient 25 may be simultaneously treated by another hollow body analogous to the first, also subject to internal negative pressure but not to an actuator (11a, 11b).

According to another embodiment of the invention, the actuator, which applies a continuous force F to the hollow body under negative pressure, is a simple strap tightened around the body of the patient and supported by the hollow body. This embodiment is shown in FIG. 14. In this figure, it is seen that a hollow body 10 is positioned on the body of a patient 27 and subject to internal negative pressure by the tube 14, which connects the hollow body to an appropriate system (not shown). A strap 28 surrounds the body 27 of the patient and the hollow body 10 to apply the latter with a continuous force F to the area of the body of the patient 27 to which the negative pressure is applied by the hollow body 10.

FIG. 15 shows a cross-section of a device 100 according to the invention including an actuator and a hollow body. The reference numbers of the various parts of the hollow body are identical to those of the corresponding parts of the hollow body 10, but followed by the letter c. In the device 100, the actuator 211 is a pneumatic system operated by a control pressure P2. In this device, the hollow body 10c defining a suction chamber is placed below the actuator 211, with the assembly consisting of the hollow body and the actuator being positioned on the area of the skin to be treated.

The bottom of the device 100, i.e., the part in the vicinity of the skin 103, forms a hollow body 10c formed by a cylindrical lateral wall 2c and a ceiling 101, with a suction chamber 5c being defined by the hollow body when the device is positioned on the skin 103. This suction chamber 5c is thus delimited by the lateral wall 2c, the ceiling 101, and the skin 103 on which the bottom of the lateral wall is pressed.

The ceiling 101 is traversed by protruding fingers 6c capable of being moved relative to the ceiling 101. The fingers 6c run through holes, with the air-tight seal being obtained by means of sealing rings 102. The protruding fingers 6c are distributed over the entire surface of the ceiling 101. Their lower part, in the vicinity of the skin to be treated 103, is rounded to allow for localised compression of the skin without causing any injury to it. The upper ends of the fingers 6c, i.e., those the farthest from the skin 103, are joined with a movable plate 104. The plate 104 may move within the inner space 105 defined by the cylindrical upper part of the lateral wall of the device 100, with this space being delimited by a cover plate 106 integrated with the upper end of the lateral wall and constituting a connecting wall at the level of the top of the lateral wall. The movable plate 1045 is subject to reduced pressure P2 on the side facing the ceiling 101 to cause the movement of the fingers 6c towards the skin 103. The upper ends of the fingers 6c include thrust washers 107, limiting the movement of the plate 104 in the direction of the ceiling 101. The airtight seal is maintained by a sealing ring 108 during the movement of the plate 104 in the space 105. Springs 109 are placed between the plate 104 and the cover plate 106, applying a return force to the plate 104 and tending to move towards the cover plate 106, such that the protruding fingers 6c are returned to their retracted position in the suction chamber 5c so that they no longer compress the skin 103.

The bottom of the device 100, i.e., the part substantially at the level of the suction chamber 5c, has on its outside one or more flexible enclosures 110. As shown in FIG. 15, a single flexible enclosure may be provided in proximity to the bottom of the lateral wall of the hollow body 10c by means of two locking ribs 111. Thus, in the embodiment shown, such a flexible enclosure thus forms a peripheral belt of the bottom of the suction chamber 5c. It would be possible to provide for the flexible enclosure not to be circular, but consist of several portions distributed regularly around the axle of the device, in which case the locking ribs would be replaced by adhesive ribs. The flexible enclosure 110 is connected to a pump that supplies an air flow sufficient to establish a pressure PO within the enclosure that is greater than atmospheric pressure. The enclosure 110 consists, e.g., of a plastic material, but the thickness of this enclosure varies such that the establishment of the pressure PO in the enclosure causes the bottom of the enclosure to move in the direction of the axle of the device 100. This results in pinching of the skin in the direction of the axis of the area being treated, keeping the device 100 in position in the selected area of the skin 103.

The suction chamber 5c is connected by a channel 112 to a vacuum pump capable of establishing a pressure P1, less than the ambient atmospheric pressure, in the suction chamber 5c. Given that the lower edge 2c of the lateral wall of the hollow body is held in a substantially airtight fashion on the skin 103, the establishment of the reduced pressure P1 in the suction chamber 5c results in a deformation of the skin in the direction of the ceiling 101.

The chamber 114 defined between the ceiling 101 and the plate 104 is connected by a channel 113 to a vacuum pump capable of establishing a pressure P2, less than the ambient atmospheric pressure, in the suction chamber 114. In these conditions, given that the chamber 114 is substantially sealed due to the sealing ring 108, the plate 104 moves in the direction of the ceiling 101, such that the protruding fingers 10c, which descend in the direction of the skin 103, create on the skin a continuous localised pressure independent of the negative pressure established in the suction chamber 5c, which can thus produce a substantial compression capable of treating, point by point, the deep layers of the skin. The plate 104 is moved by stretching the springs 109, which are arranged in an area directly connected to the atmosphere by a hole 115.

The therapist, by means of this device, can thus treat the skin by suction in a known manner, and simultaneously carry out treatment by continuous local compression that is controllable in degree by the pressure P2.

In a variant shown in FIG. 16, the device of the invention may, instead of the peripheral enclosure 110 described above, include an external support 116 attached to the edge of the lateral wall 2c of the hollow body 10c. The external support 116, if it is established around the entire periphery of the device, may be affixed as with the device of FIG. 15, by means of two locking ribs 111a. However, if it is only placed on various parts of the periphery, the locking ribs are replaced by adhesive ribs. This external support may be made of a filled plastic material, or consist of a chamber as in the embodiment of FIG. 15. This external support is different in shape to that of FIG. 15, as its end that is applied to the skin has a curve that distances it from the axle of the device. Thus, when the device of the invention is applied to the skin 103 by means of the reduced pressure P₁, the support 116 presses on the skin as would the fingers of a therapist using the device of the invention manually, with the compression thus obtained being directed in the direction of the arrow S, towards the deep layers of the skin 103.

According to another variant shown in FIG. 17, a device is provided that allows for modulation of the compressive forces generated with the external supports of the type described for FIG. 16. In the case of FIG. 17, the external supports 117, analogous to those 116 of FIG. 16, are connected to a piston 118 arranged in an actuator body 19 in which they slide. The sliding occurs in an airtight fashion due to the sealing rings 120. The actuator body 119 is affixed to the outer edge of the bottom of the lateral wall 2c of the suction chamber by means of two adhesive ribs 121. The space delimited in the actuator body 119 above the piston 118 is connected by a channel 122 to a pump capable of establishing a pressurised air pressure P₃ in this part. On the other hand, the part below the piston 118 is exposed to the outside air due to the assembly 123 arranged between the external support 117 and the actuator body 119. An elastic return may be provided that distances the external support 117 from the skin when the pressure P₃ is absent.

The therapist, when using the device according to the invention, may establish a pressure P₃ of a greater or lesser degree, it being understood that the force applied by the external support 117 is limited in order to avoid the suction chamber 5c losing its seal due to the raising of the peripheral edge 2c. It should be noted that this type of embodiment may also provide for an actuator body 119 arranged on the entire periphery of the suction chamber, or only on certain parts of the periphery.

In a highly simplified embodiment of a device of the type shown in FIG. 15, the pneumatic control obtained using the pressure P₂ can be replaced by a purely mechanical control of the movement of the protruding fingers. In this case, the part of the protruding fingers that is farther from the skin would be threaded, and a threaded wheel on the outside of the hollow body 10 could move the corresponding finger towards the skin by simple rotation in order to generate continuous localised compression. In this case, the actuator would consist of such wheels and the therapist manipulating them.

1. Device for massaging a living subject to be treated, comprising a hollow body delimiting an internal volume by a lateral wall and a connecting wall, whereby the lateral wall extends between the connecting wall and a peripheral edge intended to be held on an area of the skin of the subject to be treated, the internal volume being connected to a suction system in order to constitute, by holding the peripheral edge against the skin, at least one suction chamber capable of being placed under negative pressure relative to the environment of the device, the hollow body including, in its internal volume, at least one internal support capable of compressing the skin of the subject to be treated when the internal volume is connected to the reduced treatment pressure P₁ established by the suction system,
characterised in that:
it further includes at least one actuator to apply mechanically to the skin, by means of at least one internal support of the hollow body, a force F applied to the support(s) in a continuous manner, whether variable or not, with at least one of the internal supports thus creating a continuous localised compression on the skin.

2. Device according to claim 1, characterised in that at least one actuator exercises a force F having a value independent of the pressure P₁ established by the suction system.

3. Device according to claim 1, characterised in that the internal supports are affixed inside the hollow body.

4. Device according to claim 1, characterised in that the internal supports include at least one protruding finger and/or at least one elongated boss, the free end of which is at an adjustable distance from a regular, continuous surface passing through the peripheral edge of the lateral wall.

5. Device according to claim 1, characterised in that at least some internal supports are mobile in the hollow body due to an actuator in a translation direction substantially perpendicular to a regular, continuous surface passing through the peripheral edge of the lateral wall.

6. Device according to claim 5, characterised in that a movable support is formed by a rectilinear finger, the free end of which, orientated towards the outside of the hollow body, is rounded.

7. Device according to claim 1, characterised in that the internal volume may be divided into various suction chambers, separated by at least one internal wall, whereby each internal wall has a free edge substantially at the level of a regular, continuous surface passing through the peripheral edge of the lateral wall.

8. Device according to claim 7, characterised in that the suction chambers of the hollow body are subject, independently and/or sequentially, to one or more reduced pressure(s) by means of a distribution device.

9. Device according to claim 7, characterised in that each internal wall is connected to the lateral wall of the hollow body such that its free edge is connected to the peripheral edge of the lateral wall.

10. Device according to claim 2, characterised in that the hollow body constitutes the pressure head of an actuator including a pylon, one end of which is mechanically connected to the hollow body and the other receives a pressure base, which delivers to the pylon the continuous force F to be applied via the internal support(s) to the area(s) of skin that are under continuous compression.

11. Device according to claim 10, characterised in that the force F acting on the hollow body is applied by a pressure base suited to receive part of the body of the therapist treating the subject by means of the device.

12. Device according to claim 11, characterised in that the pressure base is a mobile connection connected to a piece of equipment carried by the therapist.

13. Device according to claim 10, characterised in that the force F acting on the hollow body is applied by clamping means supported by the subject to be treated.

14. Device according to claim 5, characterised in that a mobile support is moved by the actuator by varying a control pressure P₂ independent of the reduced pressure P1, acting in the internal volume of the hollow body.

15. Device according to claim 1, characterised in that the hollow body includes on its outside, borne by its lateral wall, at least one flexible enclosure that is deformable by pressing it against the skin of the subject to be treated, whereby the deformation of the enclosure is obtained by varying the pressure P₀ within the enclosure and causing pinching of the skin in order to join the hollow body with the skin on which it is held.

16. Device according to claim 1, characterised in that the hollow body has on its outside at least one external support suited to act on the skin via an additional continuous compression, whereby the additional continuous compression acts on an area of the skin of the subject to be treated from outside the peripheral edge of the lateral wall of the hollow body and has insufficient intensity to cancel out the pressure of the peripheral edge on the skin.

17. Device according to claim 1, characterised in that the hollow body has on its outside at least one external support suited to apply an additional continuous compression to an area of the skin of the subject to be treated from outside the peripheral edge of the lateral wall of the hollow body, with any degree of intensity not capable of cancelling out the pressure of the peripheral edge of the hollow body on the skin of the subject to be treated due to a clamping means acting externally on the hollow body and supported by the subject to be treated.

18. Device according to claim 1, characterised in that the force F generated by the actuator(s) causes sufficient deformation of the lateral walls of the hollow body to cause a constant or pulsatile reduction in the negative pressure in the internal volume due to the elasticity of the lateral wall.

19. Device according to claim 18, characterised in that the elasticity of the lateral wall is chosen such that the negative pressure in the internal volume causes a slight leak in order to generate mechanical oscillation of the lateral wall and vibration on the peripheral edge of the hollow body.
